(19) United States
(12) Patent Application Publication
(10) Pub. No.: US 2019/0037449 A1
(43) Pub. Date: Jan. 31, 2019

(54) BASE STATION AND RADIO TERMINAL

(71) Applicant: KYOCERA CORPORATION, Kyoto (JP)

(72) Inventors: Masato FUJISHIRO, Yokohama-shi, Kanagawa (JP); Chiharu YAMAZAKI, Ota-ku, Tokyo (JP); Kugo MORITA, Yokohama-shi, Kanagawa (JP)

(73) Assignee: KYOCERA CORPORATION, Kyoto (JP)

(21) Appl. No.: 16/072,442

(22) PCT Filed: Jan. 13, 2017
(86) PCT No.: PCT/JP2017/001065

§ 371 Date: Jul. 24, 2018

(30) Foreign Application Priority Data
Jan. 25, 2016 (JP) 2016-011915

(51) Int. Cl. H04W 36/00; H04W 36/38

(52) U.S. Cl. CPC H04W 36/0009; H04W 36/38

(57) ABSTRACT

A source eNB 200-1 manages at least a source cell in which a group comprised of UE 100-1 to UE 100-3 present. The source eNB 200-1 transmits one group handover command to the group, if the group is collectively handed over to a target cell. The one group handover command includes RRC configuration information for the UE 100-1 to UE 100-3.

### TECHNICAL FIELD

The present invention relates to a base station and a radio terminal used in a mobile communication system.

### BACKGROUND ART

In a mobile communication system, a radio terminal in a connected mode performs a handover from a source cell to a target cell. Specifically, the radio terminal receives a handover command instructing the handover to the target cell from the source cell and performs the handover according to the handover command.

Incidentally, if there are a plurality of radio terminals in a vehicle, the plurality of radio terminals may perform the handover all at once. In particular, if the vehicle is a train, a large number of radio terminals may perform the handover all at once. In such a case, it is desired to enable realization of an efficient handover.

### PRIOR ART DOCUMENT

### Non-Patent Document

Non Patent Document 1: 3GPP specification “TS 36.300 V12.7.0”

### SUMMARY

A base station according to a first aspect manages at least a source cell in which a group comprised of a plurality of radio terminals present. The base station comprises a controller configured to transmit one group handover command to the group, if the group is collectively handed over to a target cell. The one group handover command includes RRC configuration information for the plurality of radio terminals.

A radio terminal according to a second aspect is included in a group comprised of a plurality of radio terminals. The radio terminal comprises a controller configured to receive one group handover command transmitted from a source cell to the group, if the group is collectively handed over to a target cell. The one group handover command includes RRC configuration information for the plurality of radio terminals.

A base station according to a third aspect manages a source cell with a group comprised of a plurality of radio terminals being present. The base station comprises a controller configured to notify one group handover request message to another base station configured to manage a target cell, if the group is collectively handed over to the target cell. The one group handover request message includes handover request information of each of the plurality of radio terminals.

### BRIEF DESCRIPTION OF THE DRAWINGS

FIG. 1 is a diagram illustrating a configuration of an LTE system.

FIG. 2 is a diagram illustrating a configuration of a UE (radio terminal).

FIG. 3 is a diagram illustrating a configuration of an eNB (base station).

FIG. 4 is a diagram illustrating a configuration of a protocol stack of a radio interface in an LTE system.

FIG. 5 is a diagram illustrating a configuration of radio frame used in the LTE system.

FIG. 6 is a diagram illustrating an assumed scenario according to first and second embodiments.

FIG. 7 is a chart illustrating a handover sequence according to an operation pattern 1 of the first embodiment.

FIG. 8 is a diagram illustrating a group handover command according to an operation pattern 2 of the first embodiment.

FIG. 9 is a chart illustrating a handover sequence according to the second embodiment.

FIG. 10 is a diagram illustrating an assumed scenario according to another embodiment.

### DESCRIPTION OF THE EMBODIMENT

### Overview of Embodiments

A base station according to a first and a second embodiments manages at least a source cell in which a group comprised of a plurality of radio terminals present. The base station comprises a controller configured to transmit one group handover command to the group, if the group is collectively handed over to a target cell. The one group handover command includes RRC configuration information for the plurality of radio terminals.

The RRC configuration information may be individual RRC configuration information to be applied individually to the plurality of radio terminals.

The RRC configuration information may be common RRC configuration information to be applied in common to the plurality of radio terminals. The controller is further configured to transmit an individual handover command to each of the plurality of radio terminals. The individual handover command includes individual RRC configuration information to be applied individually to the plurality of radio terminals.

In the first embodiment, the controller is configured to transmit the one group handover command by broadcast or multicast.

In the second embodiment, the controller is configured to transmit the one group handover command by unicast to a representative radio terminal in the group. The representative radio terminal transfers the one group handover command to another radio terminal in the group.

A radio terminal according to the first and the second embodiments is included in a group comprised of a plurality of radio terminals. The radio terminal comprises a controller configured to receive one group handover command transmitted from a source cell to the group, if the group is collectively handed over to a target cell. The one group handover command includes RRC configuration information for the plurality of radio terminals.

The RRC configuration information may be individual RRC configuration information to be applied individually to the plurality of radio terminals.

The RRC configuration information may be common RRC configuration information to be applied in common to the plurality of radio terminals. The controller is further configured to receive an individual handover command transmitted to each of the plurality of radio terminals, from the source cell. The individual handover command includes individual RRC configuration information to be applied individually to the plurality of radio terminals.

In the first embodiment, the one group handover command is transmitted by broadcast or multicast.

In the second embodiment, the one group handover command is transmitted by unicast to a representative radio terminal in the group. If the radio terminal is the representative radio terminal, the controller transfers the one group handover command to another radio terminal in the group.

A base station according to the first and the second embodiments manages a source cell with a group comprised of a plurality of radio terminals being present. The base station comprises a controller configured to notify one group handover request message to another base station configured to manage a target cell, if the group is collectively handed over to the target cell. The one group handover request message includes handover request information of each of the plurality of radio terminals.

The one group handover request message includes an identifier of each of the plurality of radio terminals.

The controller is configured to receive one group handover acknowledge message notified from the other base station. The one group handover acknowledge message includes configuration information for the plurality of radio terminals.

The one group handover acknowledge message includes an identifier of each of the plurality of radio terminals.

(Configuration of Mobile Communication System)

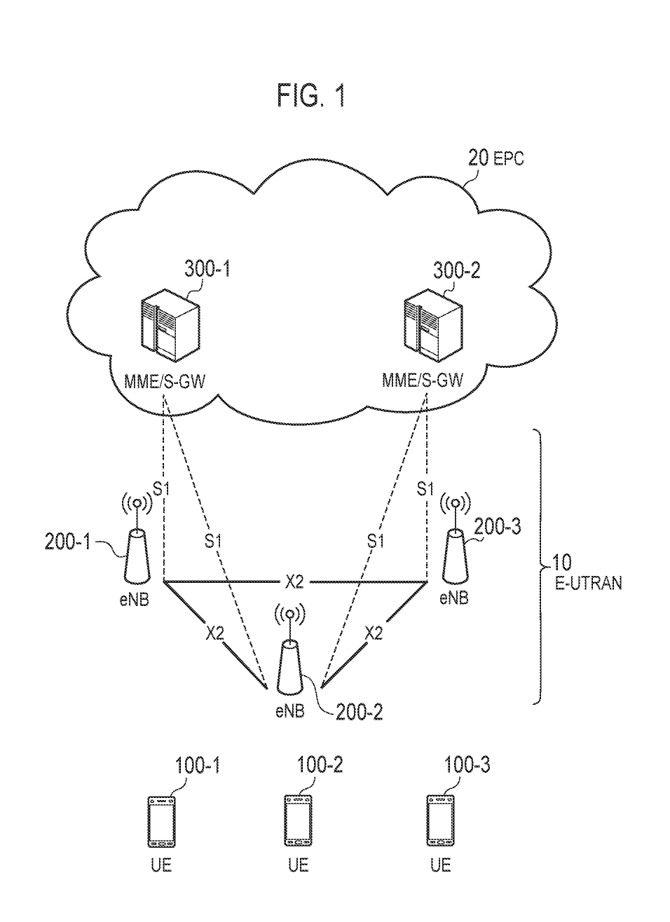

The configuration of the mobile communication system according to the embodiment will be described. FIG. 1 is a diagram illustrating a configuration of a Long Term Evolution (LTE) system being a mobile communication system according to an embodiment. As illustrated in FIG. 1, the LTE system includes a User Equipment (UE) 100, an Evolved-UMTS Terrestrial Radio Access Network (E-UTRAN) 10, and an Evolved Packet Core (EPC) 20.

The UE 100 corresponds to a radio terminal. The UE 100 is a mobile communication apparatus and performs radio communication with a cell (serving cell).

The E-UTRAN 10 corresponds to a radio access network. The E-UTRAN 10 includes an evolved Node-B (eNB) 200. The eNB 200 corresponds to a base station. The eNBs 200 are connected to each other via an X2 interface.

The eNB 200 manages one or a plurality of cells, and performs radio communication with the UE 100 that has established connection with the own cells. The eNB 200 has a radio resource management (RRM) function, a routing function of user data (hereinafter, simply referred to as “data”), a measurement control function for mobility control and scheduling, and the like. The “cell” is used as a term indicating the minimum unit of a radio communication area. The “cell” is also used as a term indicating a function of performing radio communication with the UE 100.

The EPC 20 corresponds to a core network. The EPC 20 includes a Mobility Management Entity (MME)/Serving-Gateway (S-GW) 300. The MME performs various types of mobility control for the UE 100, and the like. The S-GW performs transfer control of data. The MME/S-GW 300 is connected with the eNB 200 via an S1 interface.

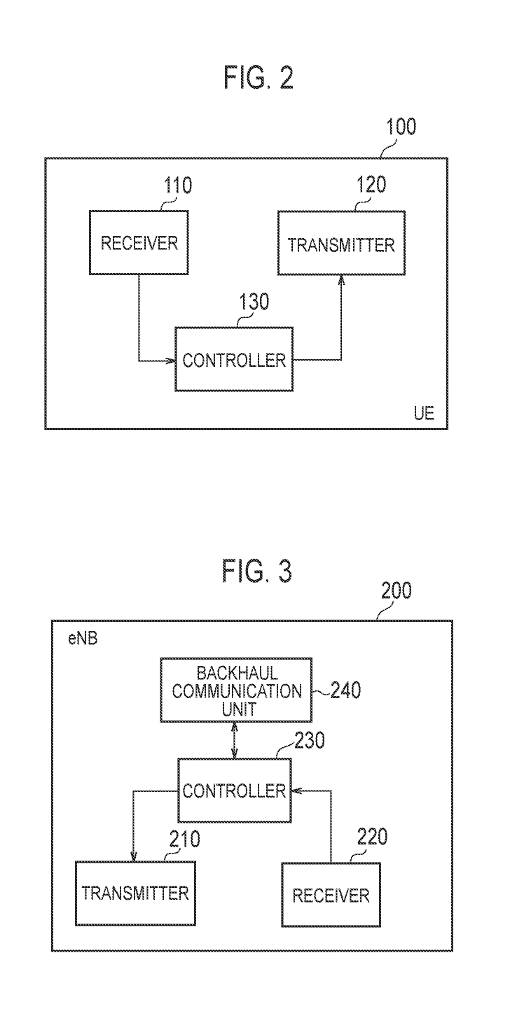

FIG. 2 is a diagram illustrating configuration of the UE 100 (radio terminal). As illustrated in FIG. 2, the UE 100 includes a receiver 110, a transmitter 120, and a controller 130.

The receiver 110 performs various types of reception under the control of the controller 130. The receiver 110 includes an antenna and a receiving device. The receiving device converts a radio signal received by the antenna, into a baseband signal (reception signal). The receiving device outputs the baseband signal to the controller 130.

The transmitter 120 performs various types of transmission under the control of the controller 130. The transmitter 120 includes an antenna and a transmission device. The transmission device converts a baseband signal (transmission signal) output by the controller 130, into a radio signal. The transmission device transmits the radio signal from the antenna.

The controller 130 performs various types of control in the UE 100. The controller 130 includes a processor and a memory. The memory stores a program to be executed by the processor, and information to be used in processing performed by the processor. The processor includes a baseband processor and a central processing unit (CPU). The baseband processor performs modulation/demodulation and encoding/decoding of a baseband signal, and the like. The CPU executes programs stored in the memory, to perform various types of processing. The processor may include a codec that performs encoding/decoding of an audio/video signal. The processor executes processes to be described later.

FIG. 3 is a diagram illustrating configuration of the eNB 200 (base station). As illustrated in FIG. 3, the eNB 200 includes a transmitter 210, a receiver 220, a controller 230, and a backhaul communication unit 240.

The transmitter 210 performs various types of transmission under the control of the controller 230. The transmitter 210 includes an antenna and a transmission device. The transmission device converts a baseband signal (transmission signal) output by the controller 230, into a radio signal. The transmission device transmits the radio signal from the antenna.

The receiver 220 performs various types of reception under the control of the controller 230. The receiver 220 includes an antenna and a receiving device. The receiving device converts a radio signal received by the antenna, into a baseband signal (reception signal). The receiving device outputs the baseband signal to the controller 230.

The controller 230 performs various types of control in the eNB 200. The controller 230 includes a processor and a memory. The memory stores a program to be executed by the processor, and information to be used in processing performed by the processor. The processor includes a baseband processor and a central processing unit (CPU). The baseband processor performs modulation/demodulation and encoding/decoding of a baseband signal, and the like. The CPU executes programs stored in the memory, to perform various types of processing. The processor executes the processor to be described later.

The backhaul communication unit 240 is connected with an adjacent eNB 200 via the X2 interface. The backhaul communication unit 240 is connected with the MME/S-GW 300 via the S1 interface. The backhaul communication unit 240 is used for communication performed on the X2 interface, communication performed on the S1 interface, and the like.

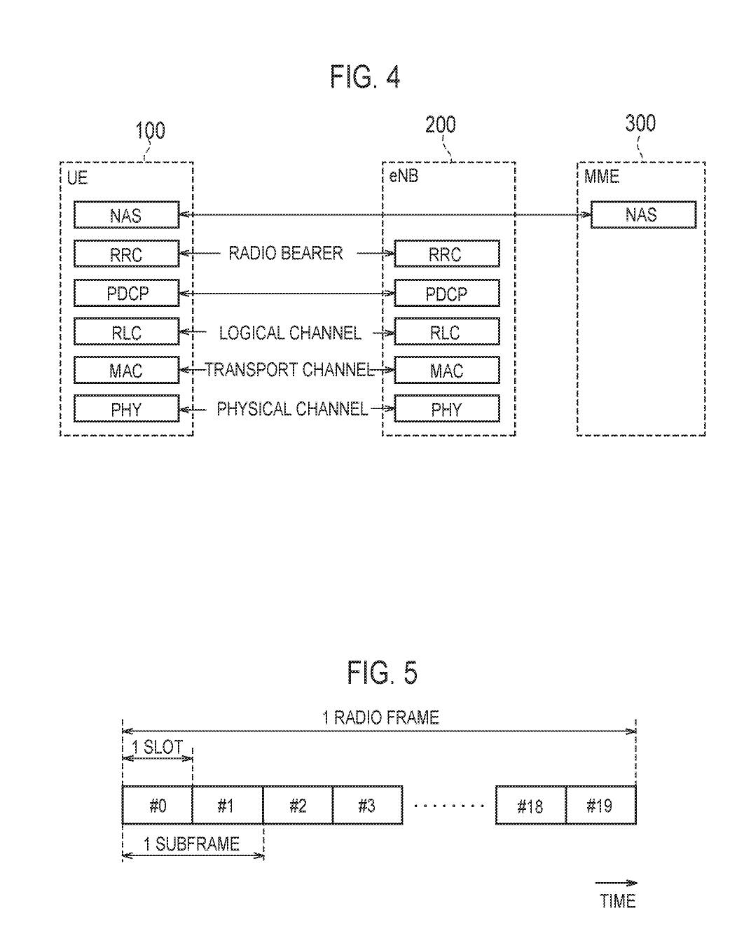

FIG. 4 is a diagram illustrating protocol stack of a radio interface in the LTE system. As illustrated in FIG. 4, a radio interface protocol is separated into first to third layers of an Open Systems Interconnection (OSI) reference model. The first layer is a physical (PHY) layer. The second layer includes a Medium Access Control (MAC) layer, a Radio Link Control (RLC) layer, and a Packet Data Convergence Protocol (PDCP) layer. The third layer includes a Radio Resource Control (RRC) layer.

The physical layer performs encoding/decoding, modulation/demodulation, antenna mapping/demapping, and resource mapping/demapping. Between the physical layer of the UE 100 and the physical layer of the eNB 200, data and control information are transferred via a physical channel.

The MAC layer performs data priority control, retransmission processing using a hybrid automatic repeat request (ARQ) (HARQ), a random access procedure, and the like. Between the MAC layer of the UE 100 and the MAC layer of the eNB 200, data and control information are transferred via a transport channel. The MAC layer of the eNB 200 includes a scheduler. The scheduler decides a transport format (transport block size and modulation and coding schemes (MCS)) of uplink and downlink, and a resource block to be allocated to the UE 100.

The RLC layer transfers data to an RLC layer on a reception side using the functions of the MAC layer and the physical layer. Between the RLC layer of the UE 100 and the RLC layer of the eNB 200, data and control information are transferred via a logical channel.

The PDCP layer performs header compression/decompression, and encryption/decryption.

The RRC layer is defined only in a control plane handling control information. Between the RRC layer of the UE 100 and the RRC layer of the eNB 200, messages (RRC messages) for various configurations are transferred. The RRC layer controls the logical channel, the transport channel, and the physical channel in response to establishment, re-establishment, and release of a radio bearer. If there is connection (RRC connection) between the RRC of the UE 100 and the RRC of the eNB 200, the UE 100 is in an RRC connected mode. If there is not a connection (RRC connection) between the RRC of the UE 100 and the RRC of the eNB 200, the UE 100 is in an RRC idle mode.

A non-access stratum (NAS) layer located above the RRC layer performs session management, mobility management, and the like.

FIG. 5 is a configuration diagram of a radio frame used in the LTE system. In the LTE system, Orthogonal Frequency Division Multiple Access (OFDMA) is applied to downlink. In the LTE system, Single Carrier Frequency Division Multiple Access (SC-FDMA) is applied to uplink.

As illustrated in FIG. 5, a radio frame is constituted by ten subframes arranged in a time direction. Each subframe is constituted by two slots arranged in the time direction. The length of each subframe is 1 ms, and the length of each slot is 0.5 ms. Each subframe includes a plurality of resource blocks (RBs) in a frequency direction. Each subframe includes a plurality of symbols in the time direction. Each resource block includes a plurality of subcarriers in the frequency direction. One resource element (RE) is constituted by one symbol and one subcarrier. In addition, among radio resources (time/frequency resources) to be allocated to the UE 100, a frequency resource can be identified by resource blocks and a time resource can be identified by subframes (or slots).

In downlink, a section corresponding to beginning several symbols of each subframe is a region used as a physical downlink control channel (PDCCH) for transferring mainly downlink control information. In addition, a remaining part of each subframe is a region that can be used as a physical downlink shared channel (PDSCH) for transferring mainly downlink data.

Basically, the eNB 200 transmits downlink control information (DCI) to the UE 100 using the PDCCH, and transmits downlink data to the UE 100 using the PDSCH. The downlink control information conveyed by the PDCCH includes uplink scheduling information, downlink scheduling information, and a TPC command. The uplink scheduling information is scheduling information (UL grant) related to the allocation of an uplink radio resource, and the downlink scheduling information is scheduling information related to the allocation of a downlink radio resource. The TPC command is information instructing the increase and decrease of transmission power of the uplink. For identifying a UE 100 which is a transmission destination of downlink control information, the eNB 200 includes a CRC bit scrambled using an identifier (Radio Network Temporary ID (RNTI)) of the transmission destination UE 100, in the downlink control information. For downlink control information that has a possibility of being addressed to an own UE, each UE 100 descrambles the CRC bit using the RNTI of the own UE and then performs CRC check, and thereby blind decodes the PDCCH, to detect downlink control information addressed to the own UE. The PDSCH conveys downlink data using a downlink radio resource (resource block) indicated by the downlink scheduling information.

In uplink, both end portions in the frequency direction of each subframe are regions used as a physical uplink control channel (PUCCH) for transferring mainly uplink control information. A remaining part of each subframe is a region that can be used as a physical uplink shared channel (PUSCH) for transferring mainly uplink data.

### First Embodiment

A first embodiment will be described, below.

(1) Assumed Scenario

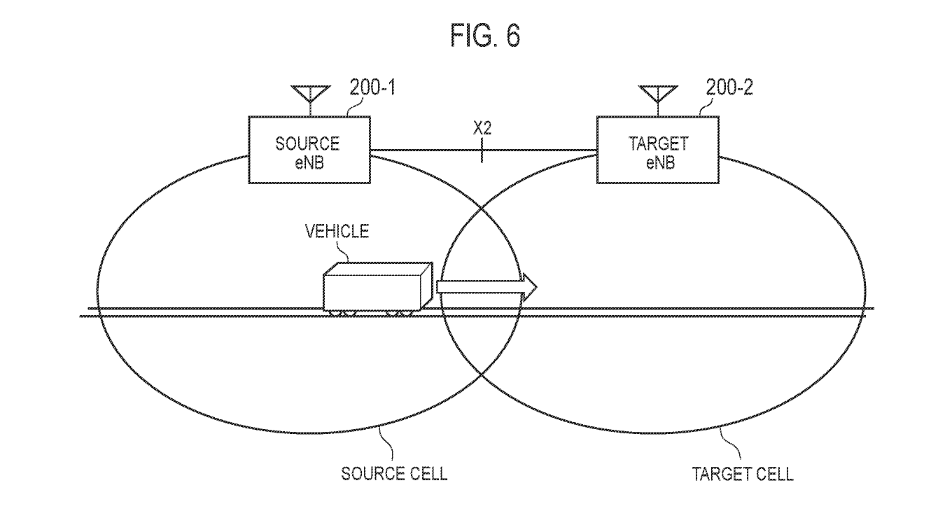

FIG. 6 is a diagram illustrating an assumed scenario according to the first embodiment. As illustrated in FIG. 6, in the first embodiment, a case is assumed where a plurality of UEs 100 are present in the vehicle and the plurality of UEs 100 perform a handover all at once.

Further, a case is assumed where the source cell and the target cell belong to a different eNB 200. Such a handover may be referred to as “inter eNB handover”. The eNB 200 configured to manage the source cell is referred to as “source eNB (Source eNB) 200-1”, and the eNB 200 configured to manage the target cell is referred to as “target eNB (Target eNB) 200-2”, below. In the first embodiment, the source eNB 200-1 and the target eNB 200-2 transmit and receive a message over an X2 interface.

(2) Operation Pattern 1

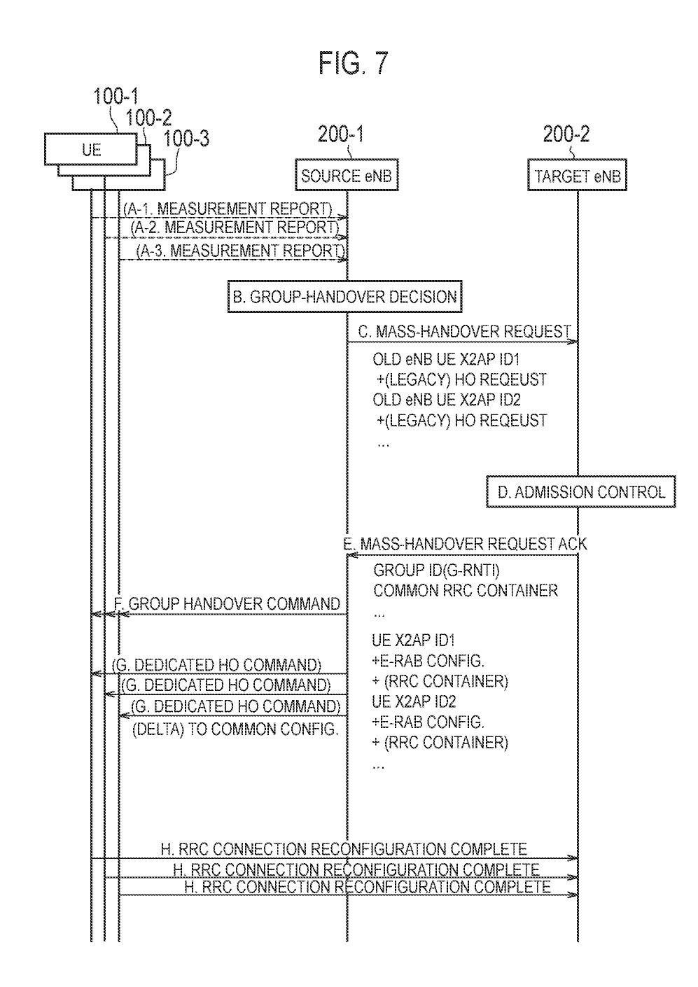

FIG. 7 is a chart illustrating a handover sequence according to an operation pattern 1. In the following example, the number of UEs 100 in the vehicle is three, but the number of UEs 100 in the vehicle may more than three and may be two.

As illustrated in FIG. 7, in step A, an UE 100-1 to an UE 100-3 in the vehicle transmit a measurement report (Measurement Report) to the source eNB 200-1. A group comprised of the UE 100-1 to the UE 100-3 may be assigned with a group identifier. The group identifier is, for example, G-RNTI (Group-Radio Network Temporary Identifier).

As a method of grouping the UE 100-1 to the UE 100-3, an MME 300 determines, for example, that the UE 100-1 to the UE 100-3 move all together to set a group comprised of the UE 100-1 to the UE 100-3. Alternatively, as a result of the eNB 200 determining, based on the measurement report or the like, that it is necessary that the UE 100-1 to the UE 100-3 perform the handover all at once, the UE 100-1 to the UE 100-3 may be grouped.

Alternatively, the source eNB 200-1 may group a plurality of UEs 100 with the same target cell (or the target eNB) and/or a plurality of UEs 100 that have transmitted the measurement report within a specific constant time period. Alternatively, the source eNB 200-1 may group, based on history information indicating a handover from the same cell within a specific constant time period, a plurality of UEs 100 estimated as being moving as a group.

Further, the eNB 200 may previously check each of the UE 100 whether or not a capability of a group handover by a UE Capability is provided, and group only the plurality of UEs 100 having the capability of the group handover.

Alternatively, a method may be such that the terminal previously notifies the base station of various groups such as a group proximity-detected by a D2D (Device to Device) direct discovery, a group performing D2D direct communication, or a group paired by WiFi direct or BT (Bluetooth (registered trademark)).

In step B, the source eNB 200-1 makes a decision of a collective handover of the source eNB 200-1 for the group comprised of the UE 100-1 to the UE 100-3 (Group-handover decision). In the following description, the collective handover may be referred to as “group handover (Group-handover)” or “mass handover (Mass-handover)”. The source eNB 200-1 may notify the UE 100 within the group of the G-RNTI or a group ID to be monitored. These identifiers are used for reception of a group handover command or the like to be described later. A timing of the notification may be before the group handover decision and may be after the group handover decision. Further, the source eNB may cancel (release) the once assigned G-RNTI and group ID, based on the determination of the source eNB itself. Such a cancellation (release) is particularly effective in a case where the G-RNTI and the group ID are notified before the group handover decision.

In step C, the source eNB 200-1 transmits one group handover request message (Mass-handover Request) to the target eNB 200-2.

The group handover request message includes handover request information (HO Request) of each of the UE 100-1 to the UE 100-3. Further, the group handover request message includes an identifier (Old eNB UE X2AP ID) of each of the UE 100-1 to the UE 100-3. It is noted that the target cell ID included in the group handover request message may be only one.

Here, the “Old eNB UE X2AP ID” is an identifier assigned by the source eNB 200-1 to the UE 100, that is, an identifier for identifying the UE 100 on an X2 interface. Further, the handover request information is information similar to that included in the existing handover request message (Legacy HO Request). For example, the handover request information includes UE context information (UE Context Information).

The group handover request message includes a list of information of each UE. The list of information of each UE includes first information for the UE 100-1, second information for the UE 100-2, and third information for the UE 100-3. The first information includes “Old eNB UE X2AP ID 1” of the UE 100-1 and “HO Request” of the UE 100-1. The second information includes “Old eNB UE X2AP ID 2” of the UE 100-2 and “HO Request” of the UE 100-2. The third information includes “Old eNB UE X2AP ID 3” of the UE 100-3 and “HO Request” of the UE 100-3. Further, the group handover request message may include the above-described G-RNTI or group ID.

In step D, the target eNB 200-2 makes, based on the group handover request message, a determination (Admission Control) whether or not to accept the group handover. Here, it is assumed that the target eNB 200-2 determines that it is possible to accept the group handover, and as such, the description proceeds.

The target eNB 200-2 assigns a new identifier (New eNB UE X2AP ID) to each of the UE 100-1 to the UE 100-3. The target eNB 200-2 may assign a new group identifier (G-RNTI) to the group comprised of the UE 100-1 to the UE 100-3.

Further, the target eNB 200-2 generates E-RAB configuration information (E-RAB config.) of each of the UE 100-1 to the UE 100-3. The E-RAB configuration information includes information of an E-RAB (E-UTRAN Radio Access Bearer).

Further, the target eNB 200-2 generates RRC configuration information (RRC Container) of each of the UE 100-1 to the UE 100-3. The RRC configuration information includes various types of configuration parameters for communication between the target eNB 200-2 and the UE 100. The RRC configuration information is information to be notified to the UE 100 from the target eNB 200-2 via the source eNB 200-1.

In the operation pattern 1, the target eNB 200-2 extracts, as common RRC configuration information (Common RRC Container), a common content out of the RRC configuration information of each of the UE 100-1 to the UE 100-3. Further, the target eNB 200-2 extracts an uncommon content as individual RRC configuration information. However, if all the RRC configuration information of each of the UE 100-1 to the UE 100-3 are common, the individual RRC configuration information may be rendered unnecessary.

In step E, the target eNB 200-2 transmits one group handover acknowledge message (Mass-handover Request ACK) including configuration information for the UE 100-1 to the UE 100-3, to the source eNB 200-1. The group handover acknowledge message includes the configuration information of each of the UE 100-1 to the UE 100-3. Further, the group handover acknowledge message includes the identifier of each of the UE 100-1 to the UE 100-3.

Specifically, in the operation pattern 1, the group handover acknowledge message includes the common RRC configuration information and the list of the information of each UE. The common RRC configuration information may include the group identifier (G-RNTI). The list of information of each UE includes the first information for the UE 100-1, the second information for the UE 100-2, and the third information for the UE 100-3.

The first information includes “Old eNB UE X2AP ID 1” of the UE 100-1, “New eNB UE X2AP ID 1” of the UE 100-1, “E-RAB config.” of the UE 100-1, and the individual RRC configuration information of the UE 100-1.

The second information includes “Old eNB UE X2AP ID 2” of the UE 100-2, “New eNB UE X2AP ID 2” of the UE 100-2, “E-RAB config.” of the UE 100-2, and the individual RRC configuration information of the UE 100-2.

The third information includes “Old eNB UE X2AP ID 3” of UE 100-3, “New eNB UE X2AP ID 3” of UE 100-3, “E-RAB config.” of the UE 100-3, and the individual RRC configuration information of the UE 100-3.

In step F, the source eNB 200-1 transmits, to the group comprised of the UE 100-1 to the UE 100-3, one group handover command (Group Handover Command). In the operation pattern 1, the group handover command includes the common RRC configuration information applied in common to the UE 100-1 to the UE 100-3.

The source eNB 200-1 transmits the group handover command by broadcast or multicast. In other words, the source eNB 200-1 transmits the group handover command to be transmitted to the UE 100-1 to the UE 100-3, in the same PDSCH resource.

As a first transmission method of the group handover command, the source eNB 200-1 transmits the group handover command via a group control channel or broadcast channel resembling to a paging channel. Further, the group handover command includes an identifier (for example, C-RNTI) or a group identifier of each of the UE 100-1 to the UE 100-3. For example, assignment information of the group control channel is transmitted on the PDCCH by using a predefined RNTI. Each UE 100 uses the predefined RNTI to specify the assignment of the group control channel, and receives the group handover command to be transmitted over the group control channel. If the identifier of each UE 100 or the group identifier of the group to which each UE 100 belongs is included in the group handover command, the UE 100 determines that the received group handover command is addressed to the UE 100.

As a second transmission method of the group handover command, the source eNB 200-1 transmits the assignment information of the group handover command over the PDCCH by using the group identifier (G-RNTI). If each UE 100 can specify the assignment of the group handover command by using the group identifier (G-RNTI) of the group to which each UE 100 belongs, each UE 100 receives the group handover command, based on the specified assignment.

In step G, the source eNB 200-1 transmits, by unicast, the individual handover command (Dedicated HO Command) to each of the UE 100-1 to the UE 100-3. The individual handover command includes the individual RRC configuration information applied individually to the UE 100-1 to the UE 100-3. As described above, the individual RRC configuration information is a difference (Delta) from the common RRC configuration information. Each UE 100 receives the individual handover command to obtain the individual RRC configuration information of each UE 100 itself. Then, each UE 100 obtains the RRC configuration information of each UE 100 by combining the individual RRC configuration information of each UE 100 and the common RRC configuration information. It is noted that, if the individual RRC configuration information is not required, step G may be omitted.

In step H, each of the UE 100-1 to the UE 100-3 performs the handover to the target eNB 200-2. Specifically, each UE 100 transmits, to the target eNB 200-2, an RRC connection reconfiguration completion message (RRC Connection Reconfiguration Complete).

(3) Operation Pattern 2

In the operation pattern 1 described above, the source eNB 200-1 transmitted the common RRC configuration information to the UE 100-1 to the UE 100-3 by using the group handover command. On the other hand, in an operation pattern 2, the source eNB 200-1 transmits the individual RRC configuration information by the group handover command.

In the operation patterns 2, the handover sequence of FIG. 7 will be changed, as described below.

Steps A to C are similar to those in the operation pattern 1.

In step D, the target eNB 200-2 makes, based on the group handover request message, a determination (Admission Control) whether or not to accept the group handover. Here, it is assumed that the target eNB 200-2 determines that it is possible to accept the group handover, and as such, the description proceeds.

The target eNB 200-2 generates E-RAB configuration information (E-RAB config.) of each of the UE 100-1 to the UE 100-3.

Further, the target eNB 200-2 generates the RRC configuration information (individual RRC configuration information) of each of the UE 100-1 to the UE 100-3. In the operation pattern 2, the target eNB 200-2 does not extract the common RRC configuration information.

In step E, the target eNB 200-2 transmits one group handover acknowledge message (Mass-handover Request ACK) including configuration information for the UE 100-1 to the UE 100-3, to the source eNB 200-1. The group handover acknowledge message includes the configuration information of each of the UE 100-1 to the UE 100-3. Further, the group handover acknowledge message includes the identifier of each of the UE 100-1 to the UE 100-3.

Specifically, the group handover acknowledge message includes a list of information of each UE. In the operation pattern 2, the group handover acknowledge message does not include the common RRC configuration information. The list of information of each UE includes the first information for the UE 100-1, the second information for the UE 100-2, and the third information for the UE 100-3.

The first information includes “Old eNB UE X2AP ID 1” of the UE 100-1, “New eNB UE X2AP ID 1” of the UE 100-1, “E-RAB config.” of the UE 100-1, and the individual RRC configuration information of the UE 100-1.

The second information includes “Old eNB UE X2AP ID 2” of the UE 100-2, “New eNB UE X2AP ID 2” of the UE 100-2, “E-RAB config.” of the UE 100-2, and the individual RRC configuration information of the UE 100-2.

The third information includes “Old eNB UE X2AP ID 3” of UE 100-3, “New eNB UE X2AP ID 3” of UE 100-3, “E-RAB config.” of the UE 100-3, and the individual RRC configuration information of the UE 100-3.

In step F, the source eNB 200-1 transmits, to the group comprised of the UE 100-1 to the UE 100-3, one group handover command (Group Handover Command). In the operation pattern 2, the group handover command includes the individual RRC configuration information applied individually to the UE 100-1 to the UE 100-3.

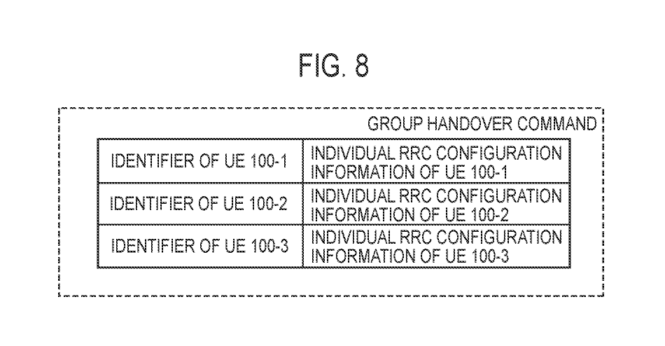

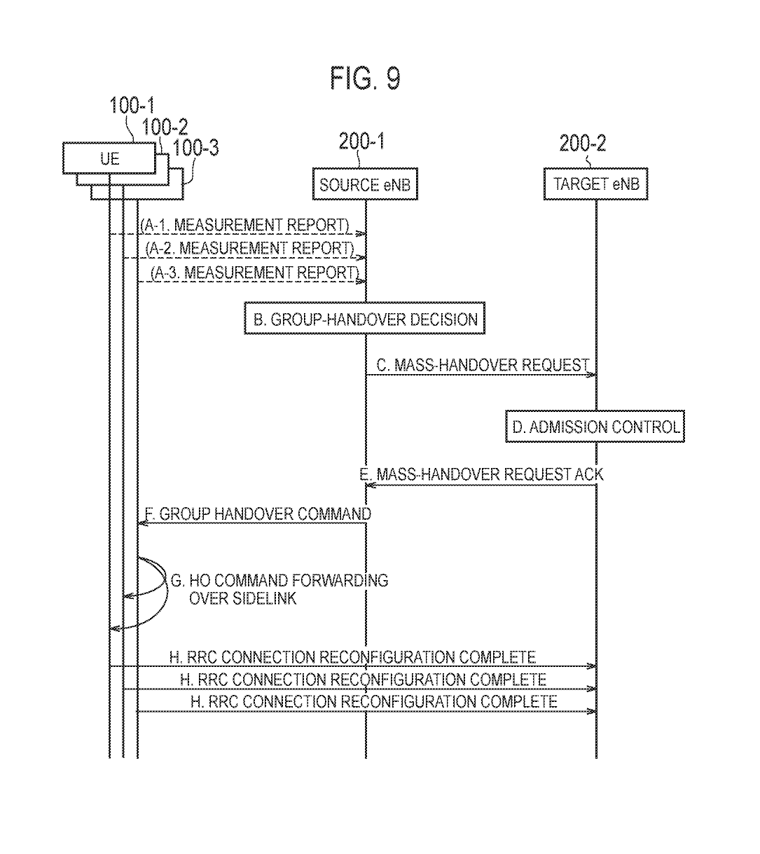

FIG. 8 is a diagram illustrating the group handover command according to the operation pattern 2. As illustrated in FIG. 8, the group handover command includes a list of the individual RRC configuration information of each UE 100. The individual RRC configuration information is added with an identifier (for example, C-RNTI) of the corresponding UE 100.

The source eNB 200-1 transmits the group handover command via the group control channel. For example, assignment information of the group control channel is transmitted on the PDCCH by using a predefined RNTI. Each UE 100 uses the predefined RNTI to specify the assignment of the group control channel, and receives the group handover command to be transmitted over the group control channel. If each UE 100 can discover, in the group handover command, the individual RRC configuration information added with the identifier of each UE 100, each UE 100 determines that the individual RRC configuration information is addressed to each UE 100. Each UE 100 may discard the individual RRC configuration information not added with the identifier of each UE 100.

It is noted that in the operation pattern 2, step G is not required. Step H is similar to that in the operation pattern 1.

### Second Embodiment

A second embodiment will be described while focusing on a difference from the first embodiment, below. In the second embodiment, a scenario similar to that in the first embodiment (see FIG. 6) will be assumed.

In the second embodiment, the source eNB 200-1 transmits, by unicast, one group handover command to a representative UE 100 in the group. As the group handover command according to the second embodiment, the group handover command according to the above-described operation pattern 1 may be used, and the group handover command according to the above-described operation pattern 2 may also be used.

The representative UE 100 according to the second embodiment is the UE 100 configured to transfer the group handover command to another UE 100 in the group. The representative UE may be referred to as “relay UE”. For the transfer of the group handover command, a sidelink or direct link between the UEs 100 is used. The representative UE 100 may transfer the group handover command by using the sidelink direct discovery function, and may transfer the group handover command by using the sidelink direct communication function. It is noted that the representative UE 100 may transfer a whole of the group handover command and may transfer only a part of the group handover command.

FIG. 9 is a chart illustrating the handover sequence according to the second embodiment. Here, a case is assumed where the UE 100-3 out of the UE 100-1 to the UE 100-3 in the vehicle is set as the representative UE 100.

As illustrated in FIG. 9, in step A, the UE 100-1 to the UE 100-3 in the vehicle transmit the measurement report (Measurement Report) to the source eNB 200-1. The group comprised of the UE 100-1 to the UE 100-3 may be assigned with the group identifier (G-RNTI). In the second embodiment, on behalf of the UE 100-1 and the UE 100-2, the UE 100-3 or representative UE 100 may transmit the measurement report to the source eNB 200-1. Specifically, the UE 100-3 receives the measurement report from each of the UE 100-1 and the UE 100-2, and transfers the received measurement report to the source eNB 200-1.

Steps B to E are similar to those in the handover sequence according to the first embodiment.

In step F, the source eNB 200-1 transmits, to the UE 100-3 or representative UE 100, one group handover command (Group Handover Command). As the group handover command, the group handover command according to the above-described operation pattern 1 may be used, and the group handover command according to the above-described operation pattern 2 may also be used.

In step G, the UE 100-3 transfers (forwards) the group handover command over the sidelink (Sidelink) to the UE 100-1 and the UE 100-2. The UE 100-1 and the UE 100-2 receive the group handover command.

In step H, each of the UE 100-1 to the UE 100-3 performs the handover to the target eNB 200-2. Specifically, each UE 100 transmits, to the target eNB 200-2, an RRC connection reconfiguration completion message (RRC Connection Reconfiguration Complete). However, only the UE 100-3 or representative UE 100 may transmit the RRC connection reconfiguration completion message to the target eNB 200-2.

### Other Embodiments

The operations according to the embodiments described above can be applied to a case where the source cell and the target cell belong to the same eNB 200. Such a case may be referred to as “intra-eNB handover”. In a case of the intra-eNB handover, the process performed by the target eNB 200-2 in the operations according to the embodiments described above is to be performed by the source eNB 200-1.

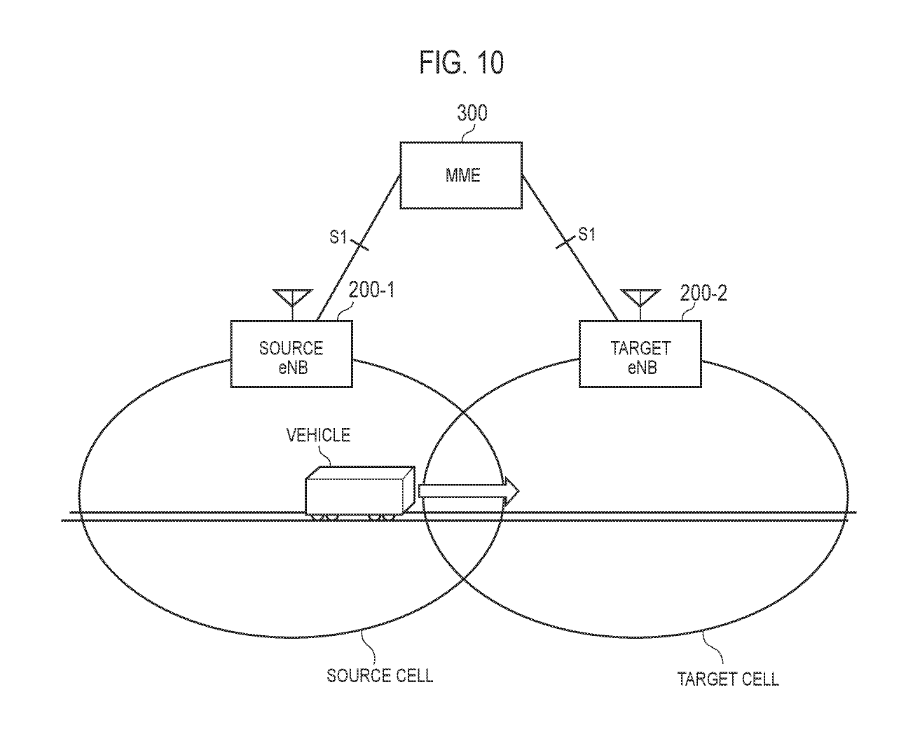

In the embodiments described above, an example was described where the source eNB 200-1 and the target eNB 200-2 transmit and receive the message over the X2 interface. However, the source eNB 200-1 and the target eNB 200-2 may transmit and receive the message over the S1 interface. FIG. 10 is a diagram illustrating an assumed scenario according to another embodiment. As illustrated in FIG. 10, the source eNB 200-1 and the target eNB 200-2 are connected to the MME 300 via the S1 interface. In the scenario illustrated in FIG. 10, the source eNB 200-1 may notify the target eNB 200-2, via the MME 300, of the group handover request message (Mass-Handover Request) according to the above embodiments. Further, the target eNB 200-2 may notify the source eNB 200-1, via the MME 300, of the group handover acknowledge message (Mass-Handover Request ACK) according to the above embodiments.

Each of the above-described embodiments may be implemented independently; two or more embodiments may be combined and implemented.

In the above-described embodiment, the LTE system is exemplified as the mobile communication system. However, the present invention is not limited to the LTE system. The present invention may apply to systems other than the LTE system.

The entire content of Japanese Patent Application No. 2016-011915 (filed on Jan. 25, 2016) is incorporated in the present specification by reference.

### INDUSTRIAL APPLICABILITY

The present invention is useful in the field of radio communication.

1. A base station configured to manage at least a source cell in which a group comprised of a plurality of radio terminals present, comprising:
a controller configured to transmit one group handover command to the group, if the group is collectively handed over to a target cell, wherein
the one group handover command includes RRC configuration information for the plurality of radio terminals.

2. The base station according to claim 1, wherein
the RRC configuration information is common RRC configuration information to be applied in common to the plurality of radio terminals,
the controller is further configured to transmit an individual handover command to each of the plurality of radio terminals, and
the individual handover command includes individual RRC configuration information to be applied individually to the plurality of radio terminals.

3. The base station according to claim 1, wherein
the RRC configuration information is individual RRC configuration information to be applied individually to the plurality of radio terminals.

4. The base station according to claim 1, wherein
the controller is configured to transmit the one group handover command by broadcast or multicast.

5. The base station according to claim 1, wherein
the controller is configured to transmit the one group handover command by unicast to a representative radio terminal in the group, and
the representative radio terminal transfers the one group handover command to another radio terminal in the group.

6. A radio terminal included in a group comprised of a plurality of radio terminals, comprising:
a controller configured to receive one group handover command transmitted from a source cell to the group, if the group is collectively handed over to a target cell, wherein
the one group handover command includes RRC configuration information for the plurality of radio terminals.

7. The radio terminal according to claim 6, wherein
the RRC configuration information is common RRC configuration information to be applied in common to the plurality of radio terminals,
the controller is further configured to receive an individual handover command transmitted to each of the plurality of radio terminals, from the source cell, and
the individual handover command includes individual RRC configuration information to be applied individually to the plurality of radio terminals.

8. The radio terminal according to claim 6, wherein
the RRC configuration information is individual RRC configuration information to be applied individually to the plurality of radio terminals.

9. The radio terminal according to claim 6, wherein
the one group handover command is transmitted by broadcast or multicast.

10. The radio terminal according to claim 6, wherein
the one group handover command is transmitted by unicast to a representative radio terminal in the group, and
if the radio terminal is the representative radio terminal, the controller transfers the one group handover command to another radio terminal in the group.

11. A base station configured to manage a source cell with a group comprised of a plurality of radio terminals being present, comprising:
a controller configured to notify one group handover request message to another base station configured to manage a target cell, if the group is collectively handed over to the target cell, wherein
the one group handover request message includes handover request information of each of the plurality of radio terminals.

12. The base station according to claim 11, wherein
the one group handover request message includes an identifier of each of the plurality of radio terminals.

13. The base station according to claim 11 wherein
the controller is configured to receive one group handover acknowledge message notified from the other base station, and
the one group handover acknowledge message includes configuration information for the plurality of radio terminals.

14. The base station according to claim 13, wherein
the one group handover acknowledge message includes an identifier of each of the plurality of radio terminals.
